(19) United States
(12) Patent Application Publication
(10) Pub. No.: US 2014/0205864 A1
(43) Pub. Date: Jul. 24, 2014

(54) RECHARGEABLE BATTERY PACK

(71) Applicant: SAMSUNG SDI CO., LTD., Yongin-si (KR)

(72) Inventors: Sang-Il Yi, Yongin-si (KR); Moon-Gil Kang, Yongin-si (KR)

(73) Assignee: SAMSUNG SDI CO., LTD., Yongin-si (KR)

(21) Appl. No.: 14/019,486

(22) Filed: Sep. 5, 2013

Related U.S. Application Data
(60) Provisional application No. 61/755,318, filed on Jan. 22, 2013.

(51) Int. Cl. H01M 2/34

(52) U.S. Cl. CPC H01M 2/34
USPC 429/7

(57) ABSTRACT

A rechargeable battery pack includes a plurality of battery cells, a connection tab electrically coupled to one or more terminals of the battery cells, a connection plate electrically coupled to the connection tab, and having an opening for accommodating a protruding portion of the connection tab, and a protective circuit module electrically coupled to the connection plate, and having a combination groove, wherein the connection plate is on a first surface of the protective circuit module to face the combination groove, and wherein the first surface of the protective circuit module faces the connection tab.

### CROSS-REFERENCE TO RELATED APPLICATION

This application claims priority to and the benefit of U.S. Provisional Application No. 61/755,318, filed on Jan. 22, 2013 in the U.S. Patent and Trademark Office, the entire content of which is incorporated herein by reference.

### BACKGROUND

1. Field

The described technology relates generally to a rechargeable battery pack.

2. Description of the Related Art

With the technical development of, and the increasing demand for, mobile devices, the demand for rechargeable batteries as energy sources is increasing. A rechargeable battery may be used in the form of a single cell or may be used in the form of a pack in which a plurality of cells are electrically connected to each other in accordance with the type of device used.

In general, a cylindrical rechargeable battery has larger capacity than that of a similar rectangular rechargeable battery or pouch-type rechargeable battery. Cylindrical rechargeable batteries may be serially electrically connected, may be electrically connected in parallel, or may be electrically connected in a mixed structure to form a rechargeable battery pack having a linear or plate structure.

The rechargeable battery pack is formed by connecting unit cells/portion cells to each other by connection tabs to form a cell pack, and by electrically connecting the connection tabs of the cell pack to a protective circuit module (PCM). The PCM is formed to protect the cell pack against overcharge, over-discharge, over-current, and electrical short.

For example, the protective circuit module may have through-holes. The ends of the connection tabs may be inserted into the through-holes, and electrically connected to the protective circuit module by soldering.

Therefore, since solder or plumbic acid is formed in a soldering region around the through-holes of the PCM, with which the ends of the connection tabs are combined, the volume of the soldering region increases beyond the volume defined by the remaining parts of the protective circuit module. As a result, because the overall volume of the protective circuit module is increased by the presence of the solder/plumbic acid, it is difficult to design a thin rechargeable battery pack.

The above information disclosed in this Background section is only for enhancement of understanding of the background of the described technology, and may therefore contain information that does not form the prior art that is already known in this country to a person of ordinary skill in the art.

### SUMMARY

The described technology provides a rechargeable battery pack having aspects of reduced volume of a protective circuit module.

An aspect of embodiments of the present invention provides a rechargeable battery pack including a protective circuit board and connection tabs enabling the reduction of the volume of a protective circuit module.

A rechargeable battery pack according to an exemplary embodiment includes a plurality of unit cells, connection tabs for electrically connecting the plurality of unit cells to each other, connection plates combined with the connection tabs, and a protective circuit module in which grooves with which the connection plates are combined are formed.

According to an exemplary embodiment of the present invention, it is possible to reduce or prevent solder/plumbic acid from being formed on the protective circuit board to reduce the volume of the rechargeable battery pack.

An embodiment of the present invention provides a rechargeable battery pack including a plurality of battery cells, a connection tab electrically coupled to one or more terminals of the battery cells, a connection plate electrically coupled to the connection tab, and having an opening for accommodating a protruding portion of the connection tab, and a protective circuit module electrically coupled to the connection plate, and having a combination groove, wherein the connection plate is on a first surface of the protective circuit module to face the combination groove, and wherein the first surface of the protective circuit module faces the connection tab.

The rechargeable battery pack may further include solder affixing the connection tab to the connection plate.

A height of solder affixing the connection tab to the connection plate may be no greater than a thickness of the protective circuit module.

An end surface of the protruding portion of the connection tab may be about level with a second surface opposite the first surface of the protective circuit module.

The connection plate may further include a plurality of protrusions.

The plurality of protrusions may be configured to provide increased surface area for contacting solder affixing the connection tab to the connection plate.

The connection plate may further include a blocking protrusion extending from an end of the connection plate in a direction substantially perpendicular to a direction of the protective circuit module.

The combination groove of the protective circuit module may accommodate the blocking protrusion, and the blocking protrusion and the protective circuit module may partially define a space for containing solder affixing the connection tab to the connection plate.

The connection plate may have a groove.

The groove may be configured to contain a portion of solder affixing the connection tab to the connection plate.

The connection plate may further include a protruding fixing portion, and the combination groove may accommodate the protruding fixing portion.

The fixing portion may be combined with the protective circuit module by press-fit.

The connection plate may include a connecting portion and a fixing portion that is narrower than the connecting portion, a top surface of the connecting portion may face the first surface of the protective circuit module, and the fixing portion may be in the combination groove.

The connection plate may be convexly shaped in a direction away from the protective circuit module.

The protective circuit module and the connection plate may contain solder affixing the connection tab to the connection plate.

A height of solder affixing the connection tab to the connection plate may be no greater than a distance from a top surface of the connection plate to a second surface of the protective circuit module, which is opposite the first surface.

The rechargeable battery pack may further include a pair of combination protrusions extending from a top surface of the connection plate, wherein upper ends of the combination protrusions are in the combination groove of the protective circuit module.

A rechargeable battery pack may include a plurality of battery cells, a connection tab electrically coupled to one or more terminals of the battery cells, a connection plate electrically coupled to the connection tab and having an opening therethrough for accommodating a protruding portion of the connection tab, and having a groove, a protective circuit module electrically coupled to the connection plate and having a combination groove, and solder affixing the connection tab to the connection plate, wherein the connection plate includes a plurality of protrusions, a blocking protrusion extending from an end of the connection plate in a direction substantially perpendicular to a direction of the protective circuit module, and a pair of combination protrusions extending from an upper surface of the connection plate and having upper ends located in the combination groove, wherein the connection plate is on a first surface of the protective circuit module to face the combination groove, and wherein the first surface of the protective circuit module faces the connection tab.

### BRIEF DESCRIPTION OF THE DRAWINGS

FIG. 1 is a perspective view schematically illustrating a rechargeable battery pack according to a first exemplary embodiment of the present invention.

FIG. 2 is an exploded perspective view of the rechargeable battery pack of FIG. 1.

FIG. 3 is a partial cross-sectional view of the rechargeable battery pack taken along the line III-III in FIG. 1.

FIG. 4 is a perspective view of a connection plate according to an exemplary variation of the first exemplary embodiment of the present invention.

FIG. 5 is a partial perspective view of a rechargeable battery pack according to a second exemplary embodiment of the present invention.

FIG. 6 is a cross-sectional view taken along the line VI-VI in FIG. 5.

FIG. 7 is a partial perspective view of a rechargeable battery pack according to a third exemplary embodiment of the present invention.

FIG. 8 is a cross-sectional view taken along the line VIII-VIII in FIG. 7.

FIG. 9 is a partial perspective view of a rechargeable battery pack according to a fourth exemplary embodiment of the present invention.

FIG. 10 is a cross-sectional view taken along the line X-X in FIG. 9.

FIG. 11 is a partial cross-sectional view of a rechargeable battery pack according to a fifth exemplary embodiment of the present invention.

FIG. 12 is a partial cross-sectional view of a rechargeable battery pack according to a sixth exemplary embodiment of the present invention.

### DETAILED DESCRIPTION

Hereinafter, exemplary embodiments of the present invention will be described in detail with reference to the accompanying drawings so that a person of ordinary skill in the art may perform embodiments of the present invention. As those skilled in the art would realize, the described embodiments may be modified in various ways, all without departing from the spirit or scope of the present invention.

The drawings and description are to be regarded as illustrative in nature, and not restrictive. Like reference numerals designate like elements throughout the specification.

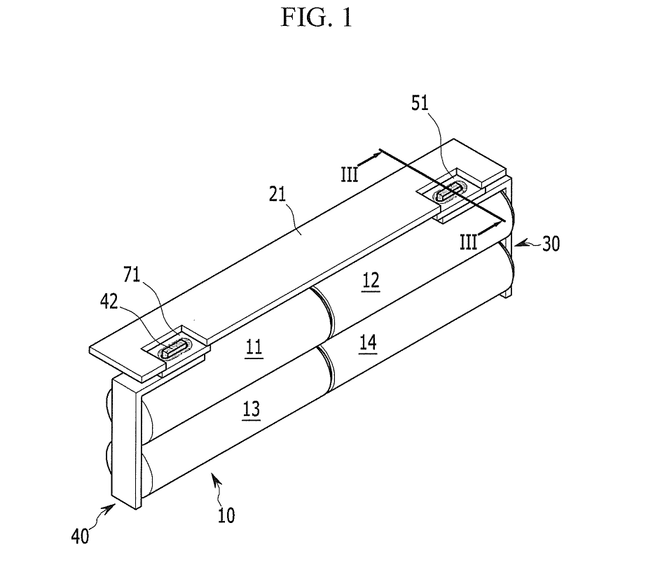

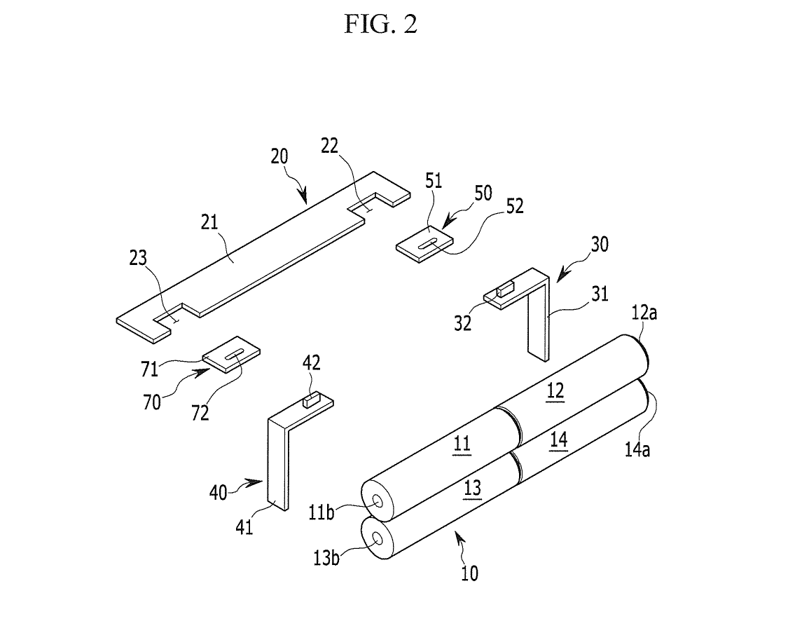

FIG. 1 is a perspective view schematically illustrating a rechargeable battery pack according to a first exemplary embodiment of the present invention. FIG. 2 is an exploded perspective view of the rechargeable battery pack of FIG. 1. Referring to FIGS. 1 and 2, a rechargeable battery pack 100 according to the present exemplary embodiment includes a unit cell group 10 including first to fourth unit cells 11, 12, 13, and 14, a protective circuit module 20 electrically connected to the unit cell group 10, a first connection tab 30, a second connection tab 40, a first connection plate 50, and a second connection plate 70.

In the unit cell group 10 according to the present exemplary embodiment, the first unit cell 11 and the second unit cell 12 may be serially electrically connected, the third unit cell 13 and the fourth unit cell 14 may be serially electrically connected. The serially electrically connected first and second unit cells 11 and 12 and the serially electrically connected third and fourth unit cells 13 and 14 may be electrically connected in parallel.

In the present embodiment, the first connection tab 30 is combined with positive terminals 12a and 14a of the second and fourth unit cells 12 and 14, and the second connection tab 40 is combined with negative terminals 11b and 13b of the first and third unit cells 11 and 13, so that the first and second unit cells 11 and 12 and the third and fourth unit cells 13 and 14 may be electrically connected in parallel.

The unit cell group 10 according to the present exemplary embodiment is not limited to including the four first to fourth unit cells 11, 12, 13, and 14, but may include, for example, two unit cells, or five unit cells, wherein the unit cells may be serially electrically connected and/or electrically connected in parallel.

The first to fourth unit cells 11, 12, 13, and 14 according to the present exemplary embodiment are cylindrical. However, the present invention is not limited to the above. The unit cells of the present embodiment may also be square type or pouch type.

Protective circuit elements may be mounted in the protective circuit module 20 according to the present exemplary embodiment so that the first to fourth unit cells 11, 12, 13, and 14 of the rechargeable battery pack 100 may be protected against any overcharge, over-discharge, over-current, and/or electrical short that might otherwise be generated. Also, the protective circuit module 20 according to the present exemplary embodiment may include a protective circuit board 21.

In the protective circuit board 21 according to the present exemplary embodiment, a first combination groove (e.g., groove for combining) 22 and a second combination groove 23 are formed so that the first connection plate 50 and the second connection plate 70 may be combined with, or coupled to, the first combination groove 22 and the second combination groove 23, respectively. That is, the first and second connection plates 50 and 70 can be respectively coupled to the portions of the protective circuit board that defines the first and second combination grooves 22 and 23. The first and second connection plates 50 and 70 may be formed of a conductive material to be electrically connected to the protective circuit board 21.

In addition, the first connection tab 30 according to the present exemplary embodiment may include a first body 31 and a first protruding portion 32 extended from one side of the first body 31, and the second connection tab 40 may include a second body 41 and a second protruding portion 42 extended from one side of the second body 41. For example, the first body 31 may include two sides forming a substantially right angle, and the first protruding portion 32 may extend outwardly from one of the sides.

In addition, the first connection plate 50 according to the present exemplary embodiment may include a first connecting portion 51 having a first through-hole 52 formed therein, and the second connection plate 70 may include a second connecting portion 71 having a second through-hole 72 formed therein.

According to the present embodiment, the first and second bodies 31 and 41 of the first and second connection tabs 30 and 40 may be combined with the negative electrodes 11b and 13b of the first and third unit cells 11 and 13.

In addition, the first and second protruding portions 32 and 42 of the first and second connection tabs 30 and 40, according to the present embodiment, may be respectively inserted into the first and second through-holes 52 and 72 and respectively combined with the first and second connection plates 50 and 70.

Therefore, according to the present exemplary embodiment, the unit cell group 10 and the protective circuit module 20 may be electrically connected through the first and second connection tabs 30 and 40.

In the present embodiment, the first and second protruding portions 32 and 42 of the first and second connection tabs 30 and 40 may be respectively combined with the first connecting portions 51 and 71 of the first and second connection plates 50 and 70 by soldering.

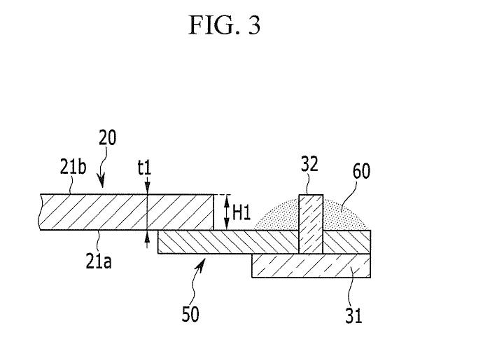

FIG. 3 is a partial cross-sectional view of the rechargeable battery pack taken along the line III-III in FIG. 1. Referring to FIG. 3, the first protruding portion 32 of the first connection tab 30 according to the present exemplary embodiment may be inserted into the first through-hole 52 formed in the first connecting portion 51 of the first connection plate 50.

Because the second connection tab 40 and the second connection plate 70 according to the present exemplary embodiment respectively have the same structure and the same combination relationship as the first connection tab 30 and the first connection plate 50, detailed description of the second connection tab 40 and the second connection plate 70 will be omitted.

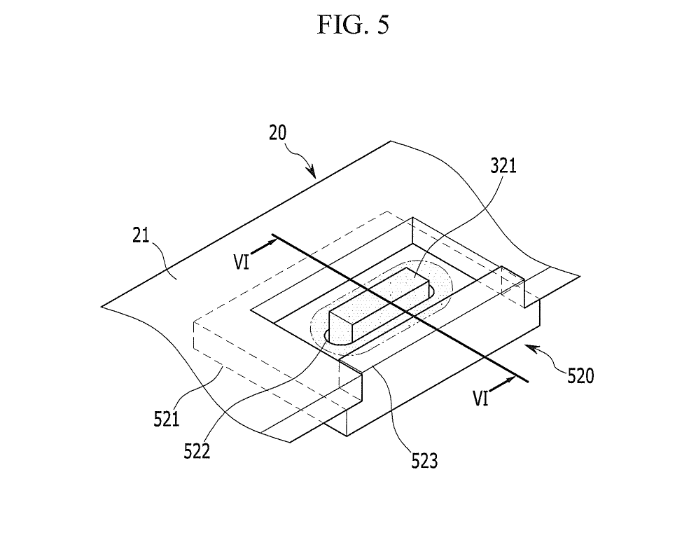

Here, the first connecting portion 51 of the first connection plate 50 may be combined with a first side surface 21a of the protective circuit board 21, and the first protruding portion 32 may be inserted into the first through-hole 52 so that an end 321 (see FIG. 5) thereof is positioned on the same plane as (e.g., is level with) a second side surface 21b of the protective circuit board 21.

In addition, the first protruding portion 32 of the first connection tab 30 and the first connecting portion 51 of the first connection plate 50 may be combined by soldering. Therefore, according to the present exemplary embodiment, a solder/plumbic acid 60 that combines the first protruding portion 32 with the first connecting portion 51 may be formed.

Here, since the end 321 of the first protruding portion 32 is at the same plane as the second side surface 21b of the protective circuit board 21, the solder/plumbic acid 60 according to the present exemplary embodiment may be formed between the second side surface 21b of the protective circuit board 21 and the first connecting portion 51 (e.g., between an area level with the second side surface 21b of the protective circuit board 21 and the first connecting portion 51). For example, the height H1 of the solder/plumbic acid 60 according to the present exemplary embodiment may be equal to, or smaller than, a thickness t1 of the protective circuit board 21 (e.g., a distance between the first side surface 21a and the second side surface 21b of the protective circuit board 21).

Therefore, according to the present exemplary embodiment, when the unit cell group 10 and the protective circuit module 20 are electrically connected by soldering, it is possible to prevent further increasing the volume of the rechargeable battery pack due to the solder/plumbic acid 60 formed on the protective circuit board 21.

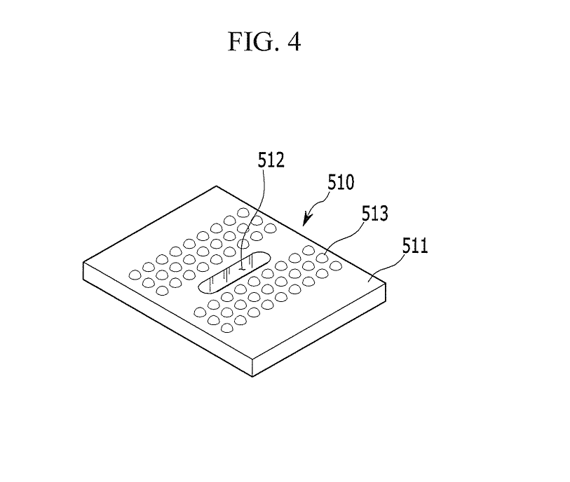

FIG. 4 is a perspective view of a connection plate according to an exemplary variation of the first exemplary embodiment of the present invention. Because the rechargeable battery pack according to the present exemplary variation/embodiment has the same structure as the rechargeable battery pack 100 of the first exemplary embodiment of the present invention, with the exception of a first connection plate 510 and a second connection plate, repeated description of their common structure will be omitted. Furthermore, because the first connection plate 510 and the second connection plate of the present exemplary embodiment have the same structure, detailed description of the second connection plate will be omitted.

The first connection plate 510 according to the present exemplary embodiment may include a first connecting portion 511 having a first through-hole 512 penetrating therethrough.

A plurality of protrusions, or bumps, 513 may be formed at the first connecting portion 511 of the first connection plate 510 according to the present exemplary embodiment. Therefore, according to the present exemplary embodiment, because the surface area of the first connecting portion 511 of the first connection plate 510 is increased by the plurality of protrusions 513, a solder/plumbic acid may be stably formed between the first connecting portion 511 and the first protruding portion 32.

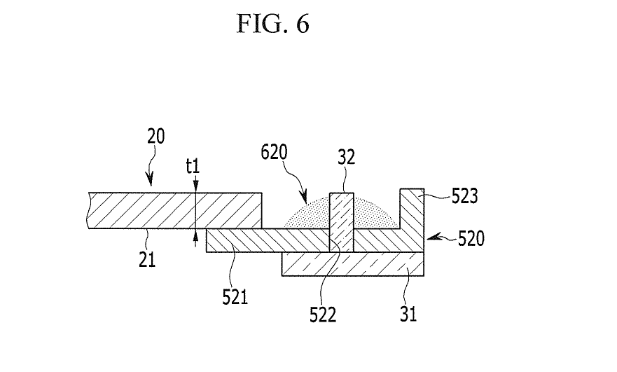

FIG. 5 is a partial perspective view of a rechargeable battery pack according to a second exemplary embodiment of the present invention. FIG. 6 is a cross-sectional view taken along the line VI-VI in FIG. 5. Because a rechargeable battery pack according to the present exemplary embodiment has the same structure as the rechargeable battery pack 100 according to the first exemplary embodiment, with the exception of a first connection plate 520 and a second connection plate, hereinafter, detailed description of commonly shared structure will be omitted. Furthermore, because the second connection plate of the present exemplary embodiment has the same structure as the first connection plate 520, detailed description of the second connection plate will be omitted.

Referring to FIGS. 5 and 6, the first connection plate 520 according to the present exemplary embodiment may include a first connecting portion 521, a first through-hole 522, and a blocking protrusion 523.

The blocking protrusion 523 of the first connection plate 520 according to the present exemplary embodiment may extend from one end of the first connecting portion 521. For example, the blocking protrusion 523 according to the present exemplary embodiment may extend from one end of the first connecting portion 521 to run approximately parallel with the direction of the thickness t1 of the protective circuit board 21. Therefore, a solder/plumbic acid 620 according to the present exemplary embodiment may be contained between the blocking protrusion 523 and the protective circuit board 21. That is, according to the present exemplary embodiment, when the first connecting portion 521 and the first protruding portion 32 are electrically connected by soldering, it is possible to use the blocking protrusion 523 at an end of the first connecting portion 521 to prevent melted solder/lead used to form the solder/plumbic acid 620 from flowing down the outside of the first connecting portion 521.

Furthermore, the blocking protrusion 523 formed in the first connection plate 520 at the end of the first connecting portion 521 may also be formed with the previously described plurality of protrusions 513 that may be formed around the first through-hole 522.

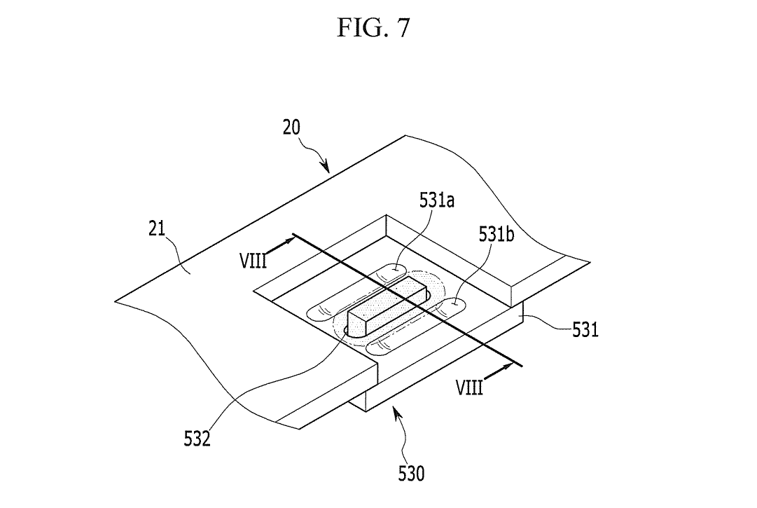

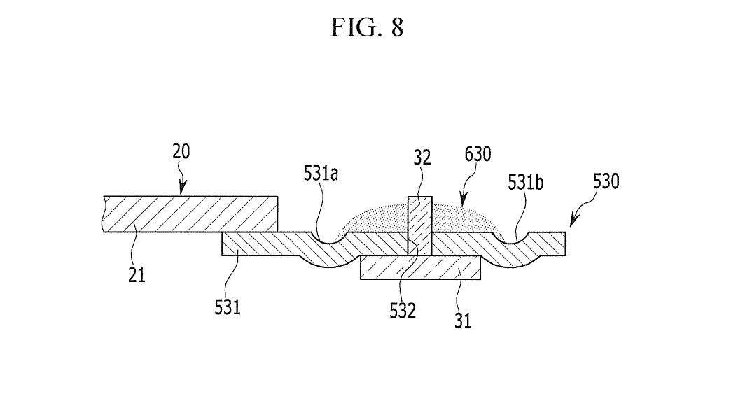

FIG. 7 is a partial perspective view of a rechargeable battery pack according to a third exemplary embodiment of the present invention. FIG. 8 is a cross-sectional view taken along the line VIII-VIII in FIG. 7.

Because a rechargeable battery pack of the embodiment shown in FIGS. 7 and 8 has the same structure as that of the rechargeable battery pack 100 according to the first exemplary embodiment of the present invention, with the exception of a first connection plate 530 and a second connection plate, further detailed description of common structure will be omitted. Further, because a second connection plate of the present exemplary embodiment has the same structure as the first connection plate 530, detailed description of the second connection plate will be omitted.

Referring to FIGS. 7 and 8, a first connection plate 530 according to the present exemplary embodiment may include a first connecting portion 531, which has first and second grooves, or indentations, 531a and 531b, and a first through-hole 532.

The first and second grooves 531a and 531b of the first connecting portion 531 of the present exemplary embodiment may be respectively formed at each of both sides of the first through-hole 532 at uniform intervals.

In the present embodiment, a solder/plumbic acid 630 may be formed between the first and second grooves 531a and 531b to couple the first connecting portion 531 to the first protruding portion 32 of the first connection tab 30. Therefore, when the first connecting portion 531 and the first protruding portion 32 are electrically connected by soldering, the first and second grooves 531a and 531b formed in the first connecting portion 531 may retain a portion of melted solder/lead used to form the solder/plumbic acid 630 to prevent it from flowing down the outside of the first connecting portion 531.

Grooves in addition to the first and second grooves 531a and 531b may be formed in the first connection plate 530 according to the present exemplary embodiment.

In other embodiments of the present invention, a blocking protrusion (such as the previously described blocking protrusion 523) may be formed at the end of the first connecting portion 531 along with the first and second grooves 531a and 531b in the first connection plate 530, and a plurality of protrusions (such as the previously described plurality of protrusions 513) may be formed around the first through-hole 532 in the first connecting portion 531.

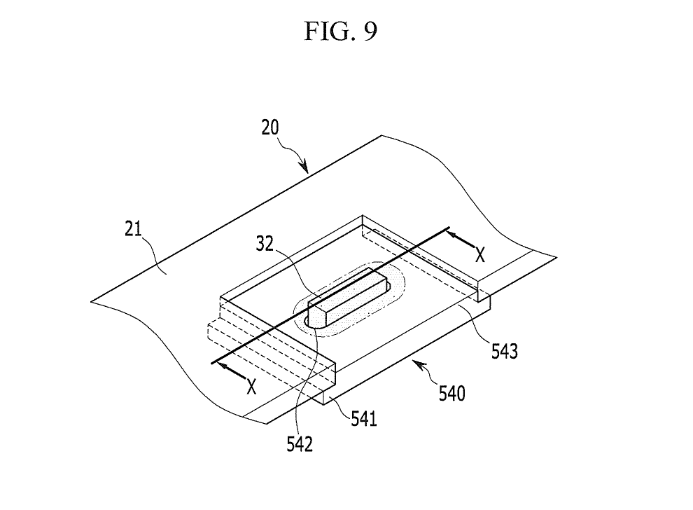

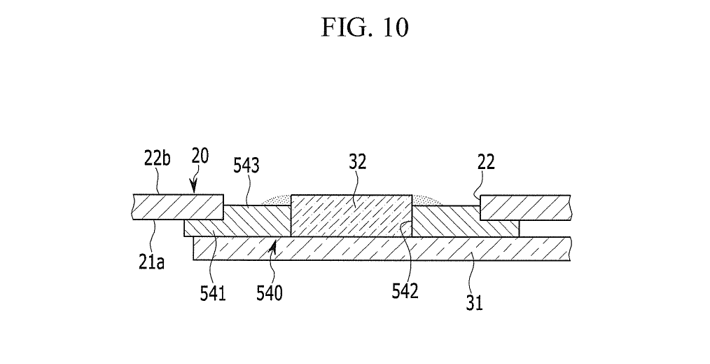

FIG. 9 is a partial perspective view of a rechargeable battery pack according to a fourth exemplary embodiment of the present invention. FIG. 10 is a cross-sectional view taken along the line X-X in FIG. 9.

Because a rechargeable battery pack according to the embodiment of FIGS. 9 and 10 has the same structure as that of the rechargeable battery pack 100 according to the first exemplary embodiment of the present invention, with the exception of a first connection plate 540 and a second connection plate, hereinafter, detailed description of common structure will be omitted.

Referring to FIGS. 9 and 10, the first connection plate 540 according to the present exemplary embodiment may include a first connecting portion 541, a first through-hole 542, and a fixing portion 543. Because the second connection plate according to the present exemplary embodiment has the same structure as that of the first connecting plate 540, detailed description of the second connection plate will be omitted.

The fixing portion 543 of the first connection plate 540 according to the present exemplary embodiment may protrude from one side surface of the first connecting portion 541 to be combined with the first combination groove 22 of the protective circuit board 21 by a press-fit technology. In further detail, the side surface of the fixing portion 543 of the present embodiment may be positioned to face the internal side surface of the first combination groove 22 (e.g., the interior edges of the protective circuit board 21 defining the first combination groove 22).

In addition, the first protruding portion 32 of the first connection tab 30 may be fixed through the first through-hole 542 to the first connecting portion 541 and the fixing portion 543. Therefore, according to the present exemplary embodiment, because the first connecting portion 541 is combined with the first side surface 21a of the protective circuit board 21 by welding, and because the fixing portion 543 is fixed to the first combination groove 22 by the press-fit technology, the first connection plate 540 may be stably combined with the protective circuit board 21.

Furthermore, fixing portions in addition to the fixing portion 543 may be formed in the first connection plate 540, according to the present exemplary embodiment.

Additionally, in the first connection plate 540 with the fixing portion 543, first and second grooves (such as the first and second grooves 531a and 531b) may be formed, a blocking protrusion (such as the previously described blocking protrusion 523) may be formed at the end of the first connecting portion 541, and/or a plurality of protrusions (such as the previously described plurality of protrusions 513) may be formed around the first through-hole 542.

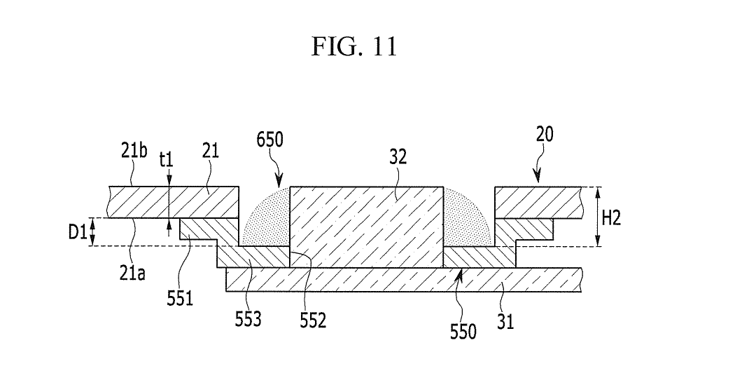

FIG. 11 is a partial cross-sectional view of a rechargeable battery pack according to a fifth exemplary embodiment of the present invention. Because a rechargeable battery pack of the embodiment of FIG. 11 has the same structure as that of the rechargeable battery pack 100 according to the first exemplary embodiment of the present invention, with the exception of a first connection plate 550 and a second connection plate, hereinafter, detailed description of common structure will be omitted. Also, because the second connection plate of the present exemplary embodiment has the same structure as that of the first connection plate 550, hereinafter, detailed description of the second connection plate will be omitted.

Referring to FIG. 11, the first connection plate 550 according to the present exemplary embodiment may include a first connecting portion 551, a first through-hole 552, and a convex portion 553. The convex portion 553 according to the present exemplary embodiment may extend from one end of the first connecting portion 551 in a direction away from the first side surface 21a of the protective circuit board 21.

In further detail, the convex portion 553 according to the present exemplary embodiment is between the first side surface 21a and the unit cell group 10, and the first through-hole 552 is formed in the convex portion 553 so that the first protruding portion 32 of the first connection tab 30 may be inserted into the first through-hole 552 to be surrounded by the convex portion 553.

Therefore, the height H2 of a solder/plumbic acid 650 formed between the convex portion 553 of the present embodiment and the first connection tab 30 may be about equal to the sum of the thickness t1 of the protective circuit board 21 and the depth D1 of the convex portion 553. As a result, because the height H2 of the solder/plumbic acid 650 may be increased by the depth D1 of the convex portion 553, the first connection plate 550 may be stably combined with the protective circuit board 21.

Furthermore, in addition to the convex portion 553 formed in the first connection plate 550, there may also be first and second grooves (such as the first and second grooves 531a and 531b) formed in the convex portion 553, a blocking protrusion (such as the previously described blocking protrusion 523) at the end of the convex portion 553, and/or a plurality of protrusions (such as the previously described plurality of protrusions 513) around the first through-hole 552, according to embodiments of the present invention.

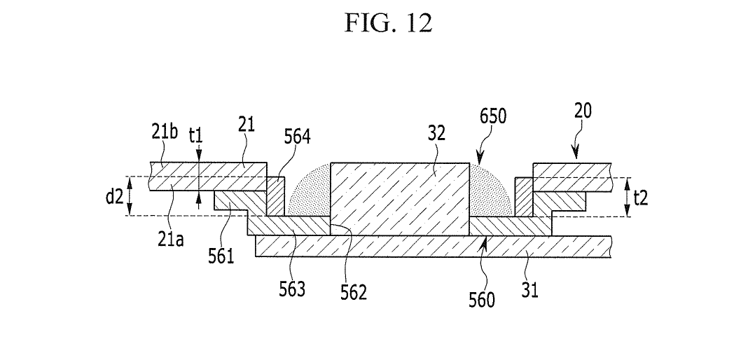

FIG. 12 is a partial cross-sectional view of a rechargeable battery pack according to a sixth exemplary embodiment of the present invention. Referring to FIG. 12, the first connection plate 560 of the present embodiment may include a first connecting portion 561, a first through-hole 562, a convex portion 563, and a first combination protrusion 564.

Because a rechargeable battery pack of the present exemplary embodiment has the same structure as the rechargeable battery pack 100 of the first exemplary embodiment of the present invention, with the exception of the first connection plate 560 and a second connection plate, repeated description of common structure will be omitted. Also, because the second connection plate of the present embodiment has the same structure as the first connection plate 560, hereinafter, detailed description of the second connection plate will be omitted. In addition, because the first connection plate 560 of the present exemplary embodiment has the same structure as the first connection plate 550 of the fifth exemplary embodiment of the present invention, with the exception of the first combination protrusion 564, hereinafter, detailed description of common structure will be omitted.

The first combination protrusion 564 of the first connection plate 560 according to the present exemplary embodiment may extend from the surface of the convex portion 563. More concretely, the first combination protrusion 564 of the present exemplary embodiment may be formed so that an end thereof may be positioned between the first side surface 21a and the second side surface 21b of the protective circuit board 21, and so that another end thereof is at the surface of the convex portion 563.

Therefore, the thickness t2 of the first combination protrusion 564 according to the present exemplary embodiment may be equal to or greater than the depth D2 of the convex portion 563, and may be less than or equal to the depth D2 of the convex portion 563 plus the thickness of the protective circuit board 21.

In addition, the first combination protrusion 564 of the present embodiment may include a pair of combination protrusions separated from the convex portion 563 at uniform intervals.

Furthermore, the first combination protrusion 564 of the present embodiment may be fixed to the first combination groove 22 by press-fit technology and/or by welding.

As a result, according to the present exemplary embodiment, because the first connection portion 561 is combined with the first side surface 21a of the protective circuit board 21, and because the first combination protrusion 564 is combined with the protective circuit board 21 via the first combination groove 22, the first connection plate 560 may be stably fixed to the protective circuit board 21.

Furthermore, in addition to the convex portion 563 and the first combination protrusion 564 formed in the first connection plate 560, first and second grooves (such as the first and second grooves 531a and 531b) may be formed in the convex portion 553, a blocking protrusion (such as the previously described blocking protrusion 523) may be formed at the end of the convex portion 553, and/or a plurality of protrusions (such as the previously described plurality of protrusions 513) may be formed around the first through-hole 552.

Additionally, it should be noted that embodiments of the present invention may include any combination of the individual aspects or features of each of the aforementioned embodiments. For example, an embodiment of the present invention may include the first and second grooves 531a and 531b of the connection plate shown in FIGS. 7 and 8, the plurality of protrusions 513 shown in FIG. 4, the blocking protrusion 523 shown in FIGS. 5 and 6, and the pair of combination protrusions 564 shown in FIG. 12.

While embodiments of the present invention have been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and their equivalents.

DESCRIPTION OF SOME OF THE REFERENCE CHARACTERS

| | |
|---|---|
| 100: rechargeable battery pack | 10: unit cell group |
| 11, 12, 13, 14: the first to fourth unit cells | |
| 20: protective circuit module | 21: protective circuit board |
| 21a: first side surface | 21b: second side surface |
| 22: first combination groove | 23: second combination groove |
| 30: first connection tab | 31: first body |
| 32: first protruding portion | 40: second connection tab |
| 41: second body | 42: second protruding portion |
| 50, 510, 520, 530, 540, 550, 560: first connection plates | |
| 51, 511, 521, 531, 541, 551, 561: first connecting portions | |
| 52, 512, 522, 532, 542, 552, 562: first through-holes | |
| 513: protrusion | 522: blocking protrusion |
| 531a: first groove | 531b: second groove |
| 543: fixing portion | 553, 563: convex portions |
| 564: first combination protrusion | 60, 620, 630, 650: solder/plumbic acid |
| 70: second connection plate | 71: second connecting portion |
| 72: second through-hole | |

What is claimed is:

1. A rechargeable battery pack comprising:
a plurality of battery cells;
a connection tab electrically coupled to one or more terminals of the battery cells;
a connection plate electrically coupled to the connection tab, and having an opening for accommodating a protruding portion of the connection tab; and
a protective circuit module electrically coupled to the connection plate, and having a combination groove,
wherein the connection plate is on a first surface of the protective circuit module to face the combination groove, and
wherein the first surface of the protective circuit module faces the connection tab.

2. The rechargeable battery pack of claim 1, further comprising solder affixing the connection tab to the connection plate.

3. The rechargeable battery pack of claim 2, wherein a height of solder affixing the connection tab to the connection plate is no greater than a thickness of the protective circuit module.

4. The rechargeable battery pack of claim 1, wherein an end surface of the protruding portion of the connection tab is about level with a second surface opposite the first surface of the protective circuit module.

5. The rechargeable battery pack of claim 1, wherein the connection plate further comprises a plurality of protrusions.

6. The rechargeable battery pack of claim 5, wherein the plurality of protrusions are configured to provide increased surface area for contacting solder affixing the connection tab to the connection plate.

7. The rechargeable battery pack of claim 1, wherein the connection plate further comprises a blocking protrusion extending from an end of the connection plate in a direction substantially perpendicular to a direction of the protective circuit module.

8. The rechargeable battery pack of claim 7, wherein the combination groove of the protective circuit module accommodates the blocking protrusion, and
wherein the blocking protrusion and the protective circuit module partially define a space for containing solder affixing the connection tab to the connection plate.

9. The rechargeable battery pack of claim 1, wherein the connection plate has a groove.

10. The rechargeable battery pack of claim 9, wherein the groove is configured to contain a portion of solder affixing the connection tab to the connection plate.

11. The rechargeable battery pack of claim 1, wherein the connection plate further comprises a protruding fixing portion, wherein the combination groove accommodates the protruding fixing portion.

12. The rechargeable battery pack of claim 11, wherein the fixing portion is combined with the protective circuit module by press-fit.

13. The rechargeable battery pack of claim 1, wherein the connection plate comprises a connecting portion and a fixing portion that is narrower than the connecting portion,
wherein a top surface of the connecting portion faces the first surface of the protective circuit module, and
wherein the fixing portion is in the combination groove.

14. The rechargeable battery pack of claim 1, wherein the connection plate is convexly shaped in a direction away from the protective circuit module.

15. The rechargeable battery pack of claim 14, wherein the protective circuit module and the connection plate contain solder affixing the connection tab to the connection plate.

16. The rechargeable battery pack of claim 14, wherein a height of solder affixing the connection tab to the connection plate is no greater than a distance from a top surface of the connection plate to a second surface of the protective circuit module, which is opposite the first surface.

17. The rechargeable battery pack of claim 1, further comprising a pair of combination protrusions extending from a top surface of the connection plate, wherein upper ends of the combination protrusions are in the combination groove of the protective circuit module.

18. A rechargeable battery pack comprising:
a plurality of battery cells;
a connection tab electrically coupled to one or more terminals of the battery cells;
a connection plate electrically coupled to the connection tab and having an opening therethrough for accommodating a protruding portion of the connection tab, and having a groove;
a protective circuit module electrically coupled to the connection plate and having a combination groove; and
solder affixing the connection tab to the connection plate,
wherein the connection plate comprises:
a plurality of protrusions;
a blocking protrusion extending from an end of the connection plate in a direction substantially perpendicular to a direction of the protective circuit module; and
a pair of combination protrusions extending from an upper surface of the connection plate and having upper ends located in the combination groove,
wherein the connection plate is on a first surface of the protective circuit module to face the combination groove, and
wherein the first surface of the protective circuit module faces the connection tab.
